(19) United States
(12) Patent Application Publication
(10) Pub. No.: US 2020/0001686 A1
(43) Pub. Date: Jan. 2, 2020

(54) SHADING DEVICE FOR A WINDOW OF A MOTOR VEHICLE

(71) Applicants: Timo MARZINKE, Stuttgart (DE); Bernd JONAS, Rohrau (DE); Dietmar ELLEDER, Korntal-Münchingen (DE); Adrian BUCUR, Esslingen (DE); Matthias MAIER, Esslingen (DE); György MOLNAR, Kirchentellinsfurt (DE); Jürgen HILBERT, Ostfildern (DE)

(72) Inventors: Timo MARZINKE, Stuttgart (DE); Bernd JONAS, Rohrau (DE); Dietmar ELLEDER, Korntal-Münchingen (DE); Adrian BUCUR, Esslingen (DE); Matthias MAIER, Esslingen (DE); György MOLNAR, Kirchentellinsfurt (DE); Jürgen HILBERT, Ostfildern (DE)

(21) Appl. No.: 16/310,856

(22) PCT Filed: Jun. 30, 2017
(86) PCT No.: PCT/EP2017/066381

§ 371 Date: Dec. 18, 2018

(30) Foreign Application Priority Data
Jul. 4, 2016 (DE) 10 2016 212 165.0

(51) Int. Cl. B60J 1/20; B60J 3/02; B60J 7/00; E06B 9/68

(52) U.S. Cl. CPC B60J 1/2063; B60J 3/02; F16H 2001/323; B60J 7/0015; E06B 9/68; B60J 1/2055

(57) ABSTRACT

Shading device with a shading structure windably held on a winding shaft arranged in a vehicle-mounted receiving region with a passage through which the shading structure is pulled into a shading position or wound up into an inoperative position. The passage is closed or opened by a pivotably mounted closing part. The shading structure is provided with a profile movable along the window with the aid of a drive system to shift the shading structure between the inoperative and shading positions. The closing part is controlled by a control mechanism between closed and opening positions depending on a shifting movement of the pull-out profile. The control mechanism has a rotatable eccentric disk operatively connected to the closing part, the outer circumference of which has different control contours for reproducing the closed position and the opening position of the closing part depending on a rotational position of the disk.

The invention relates to a shading device for a window of a motor vehicle, with a flexible shading structure which is held on a winding shaft so as to be able to be wound up and unwound, which winding shaft is arranged in a vehicle-mounted receiving region which is assigned a passage, through which the flexible shading structure can be pulled out into a shading position or can be wound up into an inoperative position, wherein the passage can be closed or can be opened up by means of a pivotably mounted closing part, wherein the shading structure is provided at its end region in front in the pull-out direction with a dimensionally stable pull-out profile which is movable along the window with the aid of at least one drive transmission means of a drive system in order to shift the shading structure between the inoperative position and the shading position, and wherein the closing part is forcibly controlled by means of a control mechanism between a closed position and at least one opening position depending on a shifting movement of the pull-out profile.

A shading device of this type for a window of a motor vehicle is known from DE 10 2013 006 761 A1. The known shading device is arranged in the region of a side window of a side door of the motor vehicle. A flexible shading structure in the form of a roller blind web is held on a winding shaft so as to be able to be wound up and unwound, which winding shaft is mounted rotatably in a roller blind cassette. The roller blind cassette is fastened to the side door below a door sill of the side door. The roller blind cassette is upwardly provided in the vertical direction of the vehicle with a passage which forms an opening through which the roller blind web passes. At its end region which is in front in the pull-out direction, the roller blind web has a dimensionally stable pull-out profile which can be shifted along the side window in the vertical direction of the vehicle. For this purpose, two opposite end sides of the pull-out profile are assigned drive transmission trains which are guided in lateral guide profiles of the side window. The drive transmission trains are driven by an electric drive motor. The passage through which the pull-out profile and the shading structure are moved upward or downward can be closed in the region of the door sill by a pivotable closing part which is closed in the inoperative position of the pull-out profile and of the shading structure. For an extension operation of the pull-out profile and of the shading structure, the closing part is pivoted up into its opening position. As soon as the pull-out profile and the roller blind web, i.e. the shading structure, are moved upward into their shading position in the region of the side window, the closing part is pivoted back into an intermediate position in which the passage is partially covered. For the shifting of the closing part between the closed position, the opening position and the intermediate position, control kinematics of differing design are provided. The control kinematics impinge here on the closing part depending on a shifting movement of the drive transmission trains. The control kinematics can have a Bowden cable device or a cable pull device.

It is the object of the invention to provide a shading device of the type mentioned at the beginning which permits simple and functionally reliable pivoting of the closing part.

This object is achieved in that the control mechanism has control kinematics which are derived from the drive system and have a rotatable eccentric disk which is operatively connected to the closing part and the outer circumference of which is provided with different control contours for reproducing the closed position and the at least one opening position of the closing part depending on a rotational position of the eccentric disk. The shading device according to the invention is usable in an advantageous manner for a window of a passenger vehicle, in particular for a side window of a rear region of the passenger vehicle. The solution according to the invention permits a particularly simple and functionally reliable design of the control mechanism. The desired activation of the closing part is undertaken by means of a simple rotational movement of the eccentric disk. The corresponding control contours of the eccentric disk can either act directly on an extension arranged fixedly on the closing part, or else can impinge on a movable, dimensionally stable transmission element, in particular in the form of a control slide, which transmits corresponding rotational movements of the eccentric disks to the closing part. The control contours of the eccentric disk can also be designed in the manner of slotted guides or groove guides, in which a corresponding sliding block which is connected to the transmission element or to the closing part is movable. The different control contours adjoin each other in the circumferential direction of the eccentric disk. The outer circumference should be understood as meaning both an outer edge contour of the eccentric disk and a circumferential track which is arranged by means of a corresponding groove or slotted guide at a radial distance outside an axis of rotation of the eccentric disk, but radially within the outer edge contour of the eccentric disk.

In a refinement of the invention, the eccentric disk is connected to a transmission shaft of the drive system by means of a worm drive. The transmission shaft provided is preferably a drive system shaft which is oriented coaxially with respect to a winding shaft or to a synchronous shaft and is connected in a rotationally locking manner to the winding shaft or to the synchronous shaft. A synchronous shaft of the drive system is provided when the pull-out profile is shifted on its opposite end sides between its inoperative position and its shading position by means of a respective drive transmission train. In particular, flexible thread-pitch cables or flexible racks are provided as the drive transmission trains. In the region of each drive transmission train, the synchronous shaft in each case has a suitable gear wheel which meshes with the corresponding drive transmission train and thus exerts a synchronous transmission of drive to the two drive transmission trains. The synchronous transmission of drive ensures uniform parallel shifting of the pull-out profile and therefore uniform pulling out or retraction of the shading structure. The synchronous shaft in turn is driven by a gearing of a drive motor of the drive system. The drive motor is advantageously of electrical design.

In a further refinement of the invention, the closing part is permanently forced, on the basis of torque, in the closing direction by means of a spring unit. The spring unit is preferably arranged in the region of the pivot axis of the closing part and is advantageously formed by at least one leg spring. In the case of a plurality of leg springs, the leg springs are arranged distributed at uniform distances over the length of the pivot axis of the closing part.

In a further refinement of the invention, the drive system drives the winding shaft and the at least one drive transmission means for the pull-out profile. If only an individual drive transmission means is provided, a dimensionally stable carrying rod which acts centrally on the pull-out profile and is in the form of a rack in the region of the transmission of the drive is preferably provided. If two flexible drive transmission trains are provided which are tension- and compression-proof, the drive transmission means are preferably driven synchronously with respect to a transmission of drive of the winding shaft. In the refinement, the winding shaft itself is likewise driven by a corresponding gearing of the drive system in both directions, i.e. in the pull-out direction and in the winding-up direction of the shading structure.

In a further refinement of the invention, the eccentric disk acts on a lever extension which is connected to the closing part. The control kinematics are thereby positioned relatively close to the closing part, thus resulting in a particularly space-saving arrangement of the control kinematics. The movement of the eccentric disk is coupled to an expansion or retraction movement of the flexible sheetlike structure. The eccentric disk preferably at maximum carries out a single revolution between a retracted and a completely pulled-out end position of the flexible sheetlike structure and therefore of the associated pull-out profile.

In a further refinement of the invention, the lever extension is connected to the closing part by means of an overload protection device. Damage to the drive system or to the control mechanics can thereby be avoided if an external force is exerted on the closing part in an open functional position, in particular by unintentional placing of a vehicle occupant's elbow on the closing part.

In a further refinement of the invention, the lever extension is mounted relative to the closing part so as to be pivotable to a limited extent coaxially with respect to the pivot axis of the closing part, and a spring device is provided which secures the lever extension in a defined functional position relative to the closing part. The spring device is preferably configured as a compression spring and positioned either coaxially with respect to the pivot axis or spaced apart radially from the pivot axis. The described refinement forms a mechanical overload protection device since, when an opposed torque is applied to the closing part, the lever extension can yield in the region of the eccentric disk, and therefore damage or impairment of the control kinematics cannot occur.

In a further refinement of the invention, a control slide which is acted upon by the eccentric disk acts on the closing part. The control slide is a component which is dimensionally stable and is tension and compression resistant and is preferably mounted in a linearly movable manner.

In a further refinement of the invention, the control slide has a supporting head which lies against the outer circumference of the eccentric disk. The supporting head has a sliding surface which has a low coefficient of sliding friction relative to the outer circumference of the eccentric disk.

In a further refinement of the invention, the control slide is oriented in the vertical direction of the vehicle and acts laterally on the closing part. The supporting head of the control slide is accordingly located at a lower end region of the control slide. By means of the orientation in the vertical direction of the vehicle, the control slide is inevitably already pressed by its own weight with its supporting head against the outer circumference of the eccentric disk. The wording “in the vertical direction of the vehicle” means that the main direction of extent of the control slide is oriented in the vertical direction of the vehicle. Additional inclinations in the transverse direction of the vehicle and/or in the longitudinal direction of the vehicle between 1° and 20° are covered by the wording “in the vertical direction of the vehicle”.

In a further refinement of the invention, the control slide is assigned a spring device which permanently presses the control slide against the outer circumference of the eccentric disk. This refinement is advantageous in order to permit permanent contact of the control slide against the eccentric disk even in the driving mode of the motor vehicle, i.e. even in the event of shaking or impact movements of the chassis of the motor vehicle.

Further advantages and features of the invention emerge from the claims and from the description below of preferred exemplary embodiments of the invention that are illustrated with reference to the drawings.

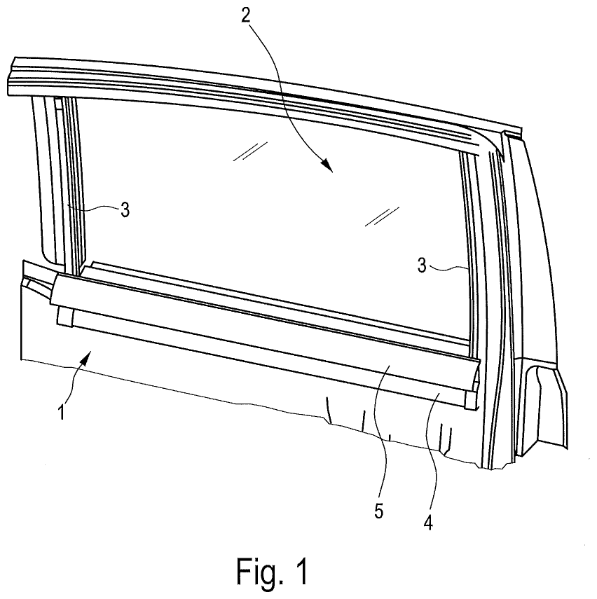

FIG. 1 shows a cutout of a side door of a motor vehicle with an embodiment of a shading device according to the invention,

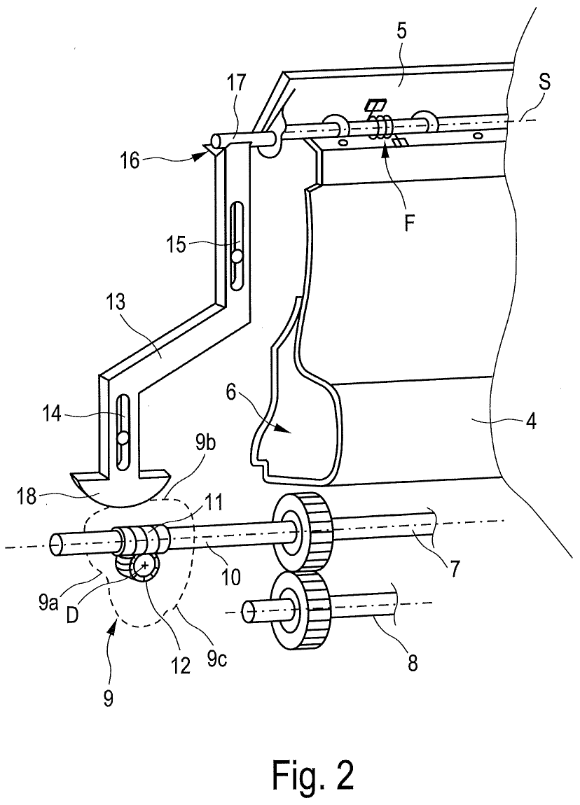

FIG. 2 schematically shows a cutout of the shading device according to FIG. 1,

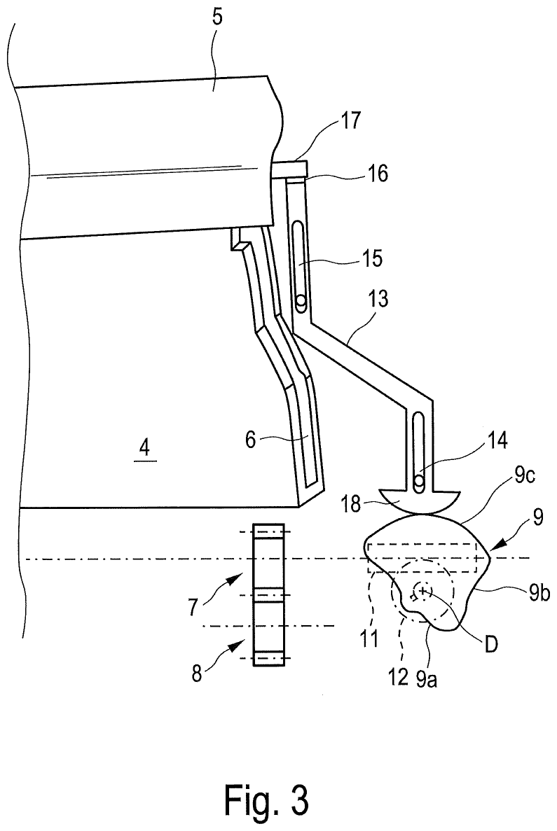

FIG. 3 schematically shows, in a view opposite to FIG. 2, the shading device according to FIG. 2 in an opening state of a closing part,

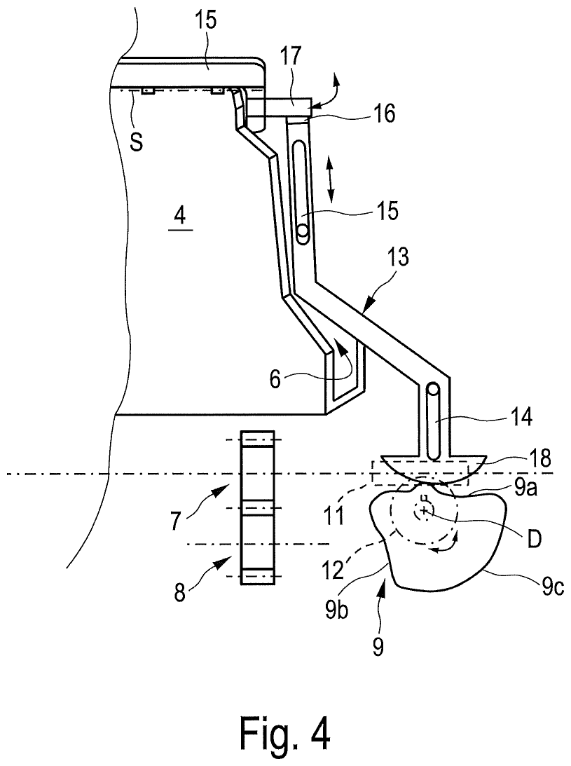

FIG. 4 schematically shows the shading device according to FIG. 3 in a closed position of the closing part,

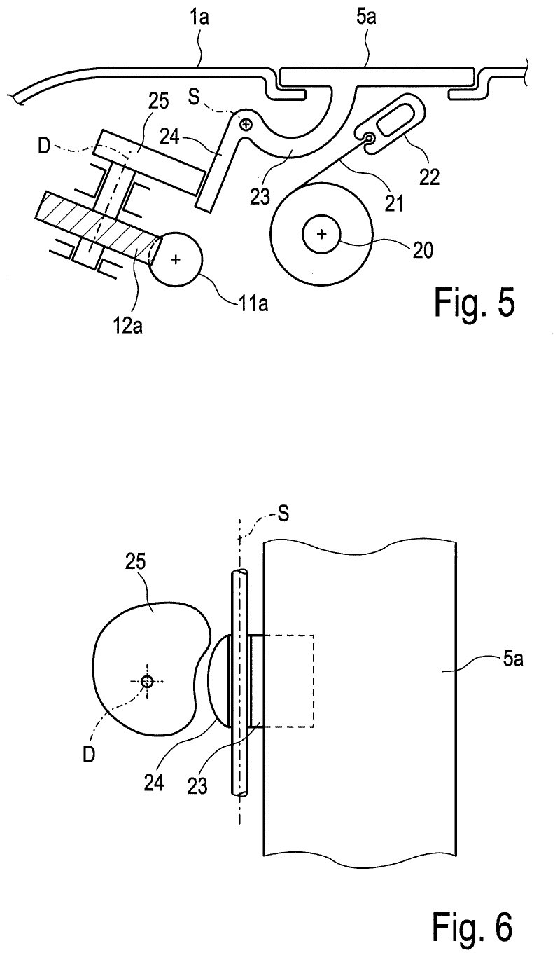

FIG. 5 schematically shows, in a sectional illustration, a cutout of a further embodiment of a shading device according to the invention,

FIG. 6 schematically shows a cutout of the shading device according to FIG. 5 in a viewing angle from above relative to FIG. 5,

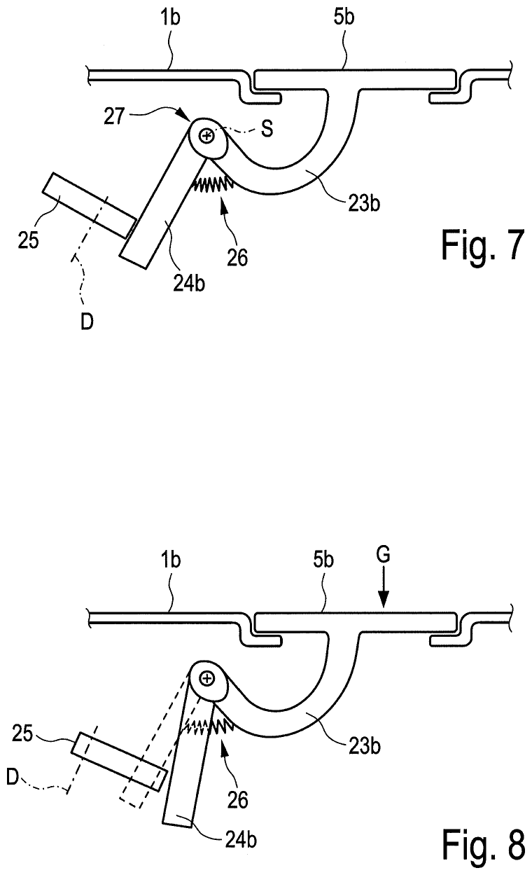

FIG. 7 schematically shows a further embodiment of a shading device according to the invention similarly to FIG. 5, and

FIG. 8 shows the shading device according to FIG. 7 with an illustration of a corresponding overload protection device for the closing part.

A passenger vehicle is designed with four doors and has two rear side doors which are each provided with a shading device which is described in more detail below. Only the rear side door which is on the left in the direction of travel will be described in more detail below; what is stated below applies analogously to the opposite rear side door.

The rear side door has a side window 2 which can be shaded by means of a flexible shading structure. The shading structure is configured as a roller blind web made from a textile woven or knitted fabric material, in particular from a knitted fabric. The roller blind web is held on a winding shaft (not illustrated) so as to be able to be wound up and unwound. The winding shaft is mounted rotatably in a receiving region 4, 6 configured as a cassette housing 4. The receiving region 4, 6 is fastened on the vehicle interior side in the region of the side door below the window 2 to an inside door structural part 1 in a manner fixed to the door. A lower edge region of a recess in the side door for the window 2 forms a door sill. The receiving region 4, 6 is arranged below the door sill. The receiving region 4, 6 is open upward in the vertical direction of the vehicle over its entire length, as seen in the longitudinal direction of the vehicle, and forms a passage (not denoted specifically) upward for the shading structure. The passage is configured to be open continuously at least over a width of the shading structure.

The receiving region 6 is surrounded by corresponding walls of the cassette housing 4. Corresponding wall regions of the cassette housing 4 also form corresponding delimitations of the passage.

The shading structure can be shifted between an inoperative position wound up on the winding shaft and a shading position which is pulled out upward substantially in the vertical direction of the vehicle and covers the window 2 on the vehicle interior side. In order to be able to shift the shading structure between the inoperative position and the shading position, the shading structure has, on its end region which is in front in the pulling-out direction, a dimensionally stable pull-out profile which can be shifted in parallel in lateral guide rails 3 along the window 2 substantially in the vertical direction of the vehicle. The lateral guide rails 3 flank the window 2 on its opposite lateral edge regions and are connected to corresponding lateral door frame portions in a manner fixed to the door.

In order to shift the pull-out profile between the inoperative position of the shading structure and the shading position of the shading structure along the guide rails 3, a drive system is provided which is partially illustrated with reference to FIGS. 2 to 4. The drive system has two flexible drive transmission trains which are guided in a linearly movable manner in the lateral guide rails 3 and are fixedly connected to one driver each which is assigned in each case to one end side of the pull-out profile. In the exemplary embodiment illustrated, the drive transmission trains are designed as flexible thread-pitch cables. In one exemplary embodiment (not illustrated) of the invention, flexible racks are provided instead of flexible thread-pitch cables.

An electrical drive motor (not illustrated) is provided for driving the drive transmission trains. The drive motor uses a flexible driveshaft 8 and a toothed gearing (not denoted specifically) to drive a synchronous shaft 7 on which two gear wheels are arranged for rotation therewith, the gear wheels synchronously driving the two drive transmission trains in the opposite guide rails 3. In the exemplary embodiment illustrated, the synchronous shaft 7 is arranged outside the cassette housing 4 and is oriented parallel to an axis of rotation of the winding shaft which is arranged within the receiving region 6 of the cassette housing 4. The winding shaft itself is likewise driven via at least one further gear wheel of the toothed gearing which is acted upon by the flexible driveshaft 8 of the electrical drive motor. Accordingly, in the case of the shading device according to the invention, both the winding shaft and the pull-out profile are driven. In order to ensure permanent tensioning of the flexible shading structure, a spring-prestressing device is integrated in the winding shaft and exerts a permanent prestress on the shading structure but is rotated together with the winding shaft by means of the drive system.

The passage above the receiving region 6 of the cassette housing 4 can be closed in the region of the door sill by a closing part 5 which is designed as a pivotable, dimensionally stable flap. The closing part 5 is permanently forced, on the basis of torque, in the closing direction by means of at least one spring unit F (FIG. 2), wherein, in the exemplary embodiment illustrated, the spring unit F is designed as a leg spring which is positioned coaxially with respect to a pivot axis S of the closing part 5 and exerts the desired torque on the closing part 5 in the closing direction.

In the inoperative position of the pull-out profile and of the shading structure, the closing part 5 is in its closed position. In order to be able to open and close the closing part 5 depending on a shifting movement of the pull-out profile and of the shading structure, the closing part 5 is assigned a control mechanism which is described in more detail below and brings about forcible guidance of the closing part 5. Said forcible guidance is derived from a rotation of a transmission shaft 10 of the drive system. In the case of the embodiment illustrated with reference to FIGS. 2 to 4, the transmission shaft 10 is extended coaxially with respect to the synchronous shaft 7 and is connected to the synchronous shaft 7 for rotation therewith. The transmission shaft 10 drives an eccentric disk 9 which is mounted rotatably about an axis of rotation D which is oriented transversely with respect to an axis of rotation of the synchronous shaft. In the case of the exemplary embodiment illustrated, an axis of rotation of the synchronous shaft 7 extends substantially in the longitudinal direction of the vehicle while the axis of rotation D of the eccentric disk 9 extends substantially in the transverse direction of the vehicle. In the exemplary embodiment illustrated, for the transmission of torque of the transmission shaft 10 to the eccentric disk 9, a worm drive 11, 12 is provided which provides a worm spindle 11 on the transmission shaft 10 and a worm wheel coaxially with respect to the axis of rotation D of the eccentric disk. The worm wheel 12 is connected to the eccentric disk 9 for rotation therewith.

The eccentric disk 9 has an outer circumference which is formed by different edge contours, as seen in the circumferential direction of the eccentric disk 9. The edge contours form, distributed over the circumference of the eccentric disk 9, a total of three different control contours 9a to 9c which each define a changed radial distance from the axis of rotation D of the eccentric disk 9. A control slide 13 which is operatively connected to the closing part 5 is supported on the respective control contour 9a to 9c of the eccentric disk 9. For this purpose, the closing part 5 has, in the region of one end side, a lever extension 17 which protrudes outward parallel to the pivot axis S from the end side of the closing part 5 in a radially offset manner with respect to the pivot axis S and which is fixedly connected to the closing part 5. The lever extension 17 is supported in a fork 16 of the control slide 13. The fork 16 is provided on an upper end region of the control slide 13. The control slide 13 is angled in the manner of a Z and is mounted so as to be longitudinally displaceable substantially in the vertical direction of the vehicle with the aid of two linear guides 14, 15. At least one linear guide 14, is assigned a spring resetting means (not illustrated specifically) which ensures that the control slide 13 is permanently pressed downward against the eccentric disk 9. The control slide 13 has, on its end region opposite the fork 16, a supporting head 18 which is of mushroom-shaped configuration and has an end edge region curved in the manner of an arc of a circle. The supporting head 18 is supported with said end edge region on the respective control contour 9a, 9b, 9c of the eccentric disk 9 in a sliding manner. Since the closing part 5 is permanently forced, on the basis of torque, in the closing direction by means of the spring unit F, shifting of the control slide 13 upward or downward in the vertical direction of the vehicle inevitably leads to corresponding opening or closing movements of the closing part 5. The control contours 9a to 9c are designed in such a manner that a first control contour 9a corresponds to a closed position of the closing part 5, a second control contour 9c corresponds to a complete opening position of the closing part 5 and a further control contour 9b corresponds to a partial opening position of the closing part 5, namely to an intermediate position of the closing part 5.

The manner of operation of the shading device according to FIGS. 1 to 4 is as follows:

If the shading structure and the pull-out profile are intended to be extended upward out of their inoperative position within the receiving region 6 of the cassette housing 4 through the passage, the drive system is activated. By this means, the driveshaft 8 rotates the synchronous shaft 7 via the corresponding gearing and moves the drive transmission trains. At the same time, the winding shaft is driven in the unwinding direction and the transmission shaft 10 rotates the eccentric disk 9, as a result of which the control slide 13 is displaced upward and opens the closing part 5. The pull-out profile and the shading structure can be extended upward through the passage and shifted upward along the window 2. At the latest whenever the pull-out profile has reached its upper end position and accordingly the shading structure has reached its shading position, the eccentric disk 9 is rotated until the control slide 13 is supported on the control contour 9b which corresponds to an intermediate position of the closing part 5. The closing part 5 is thereby partially closed again, as a result of which the passage is at least partially concealed and ensures a visually attractive contour of the door sill. The worm drive 11, 12, which is acted upon by the transmission shaft 10, is preferably designed in such a manner that the eccentric disk carries out at maximum one complete rotation through 360° over the path of movement of the pull-out profile and of the shading structure.

The embodiment according to FIGS. 5 to 6 likewise illustrates a shading device for a vehicle window of a passenger vehicle, the design of which shading device is similar to the shading device according to FIGS. 1 to 4. However, the shading device according to FIGS. 5 and 6 serves for shading a rear window of the passenger vehicle. The corresponding inside “door structural part” which forms an interior structural part 1a, is formed by a rear parcel shelf below the rear window of the passenger vehicle. A passage (not denoted specifically) which can be closed or can be opened up by a closing part 5a is provided in the interior structural part 1a.

Also in the case of the embodiment according to FIGS. 5 and 6, the closing part 5 is provided for closing a passage in the region of the inside interior structural part 1a, said closing part being mounted in the manner of a flap so as to be pivotable about a pivot axis S which is arranged below the interior structural part 1a and extends at least substantially in the longitudinal direction of the vehicle. The closing part 5a serves for opening up or closing the passage through which a pull-out profile 22 of a flexible sheetlike structure in the form of a shading structure 21 can be extended from below the interior structural part 1a or can be retracted again below the latter. The shading structure 21 is held on a winding shaft 20 so as to be able to be wound up and unwound. The winding shaft 20 is mounted rotatably below the interior structural part 1a on the door side. For shifting the pull-out profile 22 and the shading structure 21 between an inoperative position (shown in FIG. 5) and an extended functional position for shading the rear window of the passenger vehicle, a drive system is provided which corresponds to the drive system described previously with reference to FIGS. 1 to 4.

The pull-out profile 22 is guided on opposite side regions in vehicle-mounted guide rails which are provided in the region of corresponding lining parts for body pillars which flank the rear window on opposite sides. The closing part 5a is mounted pivotably about the pivot axis S by means of at least one carrier arm 23. At least one lever extension 24 protrudes in one piece from the at least one carrier arm 23. The lever extension 24 protrudes from the pivot axis S in a different direction from the carrier arm 23 and inward away from an inner side of the interior structural part 1a. The lever extension 24 is directly in contact with an eccentric disk 25 which, analogously to the embodiment according to FIGS. 1 to 4, is provided with different control contours on its circumference. The eccentric disk 25 is mounted rotatably about an axis of rotation D and is connected to a worm wheel 12a for rotation therewith, the worm wheel being driven by a worm 11a which is part of the drive system. The worm 11a is driven by the drive system for the pull-out profile 22 and the winding shaft 20 by means of a reduction gearing. The reduction ratio is configured here in such a manner that the worm wheel 12a and therefore the eccentric disk 25 execute at maximum a 360° revolution about the axis of rotation D during a shifting movement of the pull-out profile 22 between its inoperative position (FIG. 5) and an extended end position. A reduction ratio of 1:7 particularly preferably arises between a rotational speed of the winding shaft 20 and a rotational speed of the worm wheel 12a, i.e. the worm wheel 12a rotates seven times more slowly than the winding shaft 20. In a manner not illustrated specifically, a torque is permanently exerted on the closing part 5a in the closing direction, and therefore the lever extension 24 is inevitably permanently pressed against the corresponding control contours of the eccentric disk 25.

The shading device according to FIGS. 7 and 8 substantially corresponds to the shading device according to FIGS. 5 and 6. In order to avoid repetitions, reference is therefore made to the statements regarding FIGS. 5 and 6. Functionally identical parts or portions are provided with the same reference signs, sometimes with the addition of the letter b. In order to avoid repetitions, only the differences of the embodiment according to FIGS. 7 and 8 will be discussed below.

A substantial difference in the embodiment according to FIGS. 7 and 8 is that the closing part 5b is assigned an overload protection device. For this purpose, the lever extension 24b is mounted pivotably about the pivot axis S separately from the carrier arm 23b. A stop 27 defines a merely limited pivotability of the lever extension 24b relative to the carrier arm 23b. In the normal operating position, the lever extension 24b is held pressed permanently against the end stop 27 of the carrier arm 23b by means of a spring device 26 which, in the embodiment according to FIGS. 7 and 8, is configured as a compression spring. In the illustration according to FIGS. 7 and 8, the spring device 26 presses the lever extension 24b coaxially with respect to the pivot axis S away from the carrier arm 23b against the stop 27 of the carrier arm 23b. As a result, the lever extension 24b is held relative to the carrier arm 23b in a force-limited manner approximately orthogonally. The spring device 26 is configured in such a manner that the lever extension 24b behaves relative to the carrier arm 23b as a rigid extension of the carrier arm 23b during normal functional loadings of the shading device. If, according to FIG. 8, the eccentric disk 25 shifts the lever extension 24b counterclockwise, the closing part 5b accordingly is inevitably opened. As soon as, however, an unforeseen counterforce G which is greater than the resetting force of the spring device 26 is exerted on the closing part 5b from the outside, the closing part 5b is transferred into the closed position and the rigid angle between the lever extension 24b and the carrier arm 23b is canceled (see FIG. 8). The starting position and accordingly the original starting angle of the lever extension 24b relative to the carrier arm 23b is illustrated by dashed lines in FIG. 8. By means of the overload protection device formed in such a manner, damage to or malfunction of the eccentric disk 25 and accordingly of the control kinematics of the drive system in the event of corresponding loads on the closing part 5b from the outside is avoided.

1. A shading device for a window of a motor vehicle, with a flexible shading structure which is held on a winding shaft so as to be able to be wound up and unwound, which winding shaft is arranged in a vehicle-mounted receiving region which is assigned a passage, through which the flexible shading structure can be pulled out into a shading position or can be wound up into an inoperative position, wherein the passage can be closed or can be opened up by means of a pivotably mounted closing part, wherein the shading structure is provided at its end region in front in the pull-out direction with a dimensionally stable pull-out profile which is movable along the window with the aid of at least one drive transmission means of a drive system in order to shift the shading structure between the inoperative position and the shading position, and wherein the closing part is forcibly controlled by means of a control mechanism between a closed position and at least one opening position depending on a shifting movement of the pull-out profile, wherein the control mechanism has control kinematics which are derived from the drive system and have a rotatable eccentric disk which is operatively connected to the closing part and the outer circumference of which is provided with different control contours for reproducing the closed position and the at least one opening position of the closing part depending on a rotational position of the eccentric disk.

2. The shading device as claimed in claim 1, wherein the eccentric disk is connected to a transmission shaft of the drive system by means of a worm drive.

3. The shading device as claimed in claim 1, wherein the closing part is permanently forced, on the basis of torque, in the closing direction by means of a spring unit.

4. The shading device as claimed in claim 1, wherein the drive system drives the winding shaft and the at least one drive transmission means for the pull-out profile.

5. The shading device as claimed in claim 1, wherein the control contours for the at least one opening position and the closed position are at different radial distances from an axis of rotation of the eccentric disk.

6. The shading device as claimed in claim 1, wherein the eccentric disk acts on a lever extension which is connected to the closing part.

7. The shading device as claimed in claim 6, wherein the lever extension is connected to the closing part by means of an overload protection device.

8. The shading device as claimed in claim 7, wherein the lever extension is mounted relative to the closing part so as to be pivotable to a limited extent coaxially with respect to the pivot axis of the closing part, and in that a spring device is provided which secures the lever extension in a defined functional position relative to the closing part.

9. The shading device as claimed in claim 1, wherein a control slide which is acted upon by the eccentric disk acts on the closing part.

10. The shading device as claimed in claim 9, wherein the control slide has a supporting head which lies against the outer circumference of the eccentric disk.

11. The shading device as claimed in claim 9, wherein the control slide is oriented in the vertical direction of the vehicle and acts laterally on the closing part.

12. The shading device as claimed in claim 9, wherein the control slide is assigned a spring device which permanently presses the control slide against the outer circumference of the eccentric disk.
